(19) United States
(12) Patent Application Publication
(10) Pub. No.: US 2025/0137106 A1
(43) Pub. Date: May 1, 2025

(54) SAMARIUM-IRON-BASED RARE EARTH PERMANENT MAGNET MATERIAL CONTAINING GRAIN BOUNDARY PHASE AND PREPARATION METHOD THEREFOR AND USE THEREOF

(71) Applicant: NINGBO INSTITUTE OF MATERIALS TECHNOLOGY AND ENGINEERING, CHINESE ACADEMY OF SCIENCES, Ningbo, Zhejiang (CN)

(72) Inventors: Zhenyuan LIU, Ningbo, Zhejiang (CN); Zhuang LIU, Ningbo, Zhejiang (CN); Haibo FENG, Ningbo, Zhejiang (CN); Renjie CHEN, Ningbo, Zhejiang (CN); Aru YAN, Ningbo, Zhejiang (CN); Xiaolei GAO, Ningbo, Zhejiang (CN); Chaoqun ZHU, Ningbo, Zhejiang (CN); Wenxin CHENG, Ningbo, Zhejiang (CN)

(73) Assignee: NINGBO INSTITUTE OF MATERIALS TECHNOLOGY AND ENGINEERING, CHINESE ACADEMY OF SCIENCES, Ningbo, Zhejiang (CN)

(21) Appl. No.: 18/693,552

(22) PCT Filed: Apr. 3, 2023
(86) PCT No.: PCT/CN2023/085892

§ 371 Date: Mar. 20, 2024

(30) Foreign Application Priority Data
Nov. 22, 2022 (CN) 202211464706.4

(51) Int. Cl. C22C 38/14; C22C 33/04; C22C 38/00; C22C 38/10; H01F 1/059

(52) U.S. Cl. CPC C22C 38/14; C22C 33/04; C22C 38/002; C22C 38/005; C22C 38/10; H01F 1/059; C22C 2202/02

(57) ABSTRACT

The present invention provides a samarium-iron-based rare earth permanent magnet material containing a grain boundary phase, having a chemical formula of SmₐFe_{b}Co_{c}Ti_{d}Mₑ, wherein 0.5≤a≤1.5, 7.5≤b≤9.0, 2.0≤c≤3.0, 0.5≤d≤1.5, 0.1≤e≤2.0, and M is selected from the group consisting of B, C, Al, Si and a combination thereof. The present invention further provides a method for preparing a samarium-iron-based rare earth permanent magnet material containing a grain boundary phase, comprising providing raw materials of the alloy, melting and casting the raw materials to obtain a master alloy; and subjecting the master alloy to rapid quenching and melt-spinning to obtain the samarium-iron-based rare earth permanent magnet material containing the grain boundary phase. In the method, a problem that a non-magnetic grain boundary phase cannot be formed in the samarium-iron-based rare earth permanent magnet material due to the lack of liquid phase is solved, and the purity of the main phase is improved.

### CROSS REFERENCE TO RELATED APPLICATIONS

This application claims the priority of Chinese Patent Application No. 202211464706.4, filed with the China National Intellectual Property Administration on Nov. 22, 2022, and titled with “SAMARIUM-IRON-BASED RARE EARTH PERMANENT MAGNET MATERIAL CONTAINING GRAIN BOUNDARY PHASE AND PREPARATION METHOD THEREFOR AND USE THEREOF”, which is hereby incorporated by reference in its entirety.

### FIELD

The present invention belongs to the technical field of rare earth permanent magnet materials, and in particular relates to a samarium-iron-based rare earth permanent magnet material containing a grain boundary phase, a preparation method therefor and use thereof.

### BACKGROUND

Samarium-iron-based rare earth permanent magnet materials were discovered in the 1880s and have been developed for 40 years. At present, the price of rare earths is rising in the international market. With the fast development of China's new energy automobile industry, the demand for rare earth permanent magnet materials has further increased. It is urgent to develop permanent magnets with low rare earth content and high magnetic energy product. Samarium-iron-based permanent magnet material has the lowest content of rare earth elements, low cost, high anisotropy field, high saturation magnetization, and high theoretical magnetic energy product, and has a Curie temperature reaching 500° C. or more, which can be used in the field of high temperature magnetic materials.

At present, there are mainly three methods for preparing samarium-iron-based rare earth permanent magnet materials: sintering method, oxidation-reduction method, and rapid quenching method. The sintering method generally comprises smelting pure metal elements into alloy ingots, then crushing the ingots into micron powder, and then orienting, profiling, and sintering the micron powder into a block magnet. However, this method has a slow cooling rate, and the prepared magnet generally has large grain size and low coercive force. The oxidation-reduction method comprises ball milling various raw materials of oxide powders under high energy in a ball mill and performing reduction to prepare alloy powder. However, this method is not suitable for large-scale production. The rapid quenching method generally comprises performing rapid cooling to prepare nanoscale grains of samarium-iron-based rare earth permanent magnet materials. This method is simple to operate and convenient for industrial production.

However, since there is no liquid phase in the phase area of the samarium-iron-based rare earth permanent magnet material, it is difficult to form a continuous and uniform non-magnetic grain boundary phase, so that the actual coercive force differs greatly from the theoretical coercive force. Researchers engaged in rare-earth permanent magnet materials have been working hard to construct a samarium-iron-based rare-earth permanent magnet rapid quenching stripe in which the non-magnetic grain boundary phase wraps the main phase in the samarium-iron-based rare-earth permanent magnet material, which is also one of the hot topics in the field of magnet materials research in recent years.

### SUMMARY

In view of this, an object of the present invention is to provide a samarium-iron-based rare earth permanent magnet material containing a grain boundary phase, a preparation method therefor and use thereof. The samarium-iron-based rare earth permanent magnet material containing a grain boundary phase provided by the present invention has a grain boundary phase, thereby having good performance.

The present invention provides a samarium-iron-based rare earth permanent magnet material containing a grain boundary phase, having a chemical formula of:

SmₐFe_{b}Co_{c}Ti_{d}Mₑ formula I;
wherein, 0.5≤a≤1.5, 7.5≤b≤9.0, 2.0≤c≤3.0, 0.5≤d≤1.5, 0.1≤e≤2.0, and
M is selected from the group consisting of B, C, Al, Si and a combination thereof.

Preferably, the samarium-iron-based rare earth permanent magnet material containing the grain boundary phase comprises:
a Sm—Fe-based main phase, a grain boundary phase and an a-Fe phase;
wherein there is segregation distribution of non-magnetic elements in the grain boundary phase; and
the grain boundary phase is wrapped on the surface of the samarium-iron-based main phase.

Preferably, the samarium-iron-based main phase is in a volume content of 70-99% in the samarium-iron-based rare earth permanent magnet material containing the grain boundary phase;
the grain boundary phase is in a volume content of 1-30% in the samarium-iron-based rare earth permanent magnet material containing the grain boundary phase; and
the α-Fe phase is in a volume content of 1-20% in the samarium-iron-based rare earth permanent magnet material containing the grain boundary phase.

Preferably, the samarium-iron-based main phase has a grain size of 20-500 nm;
the grain boundary phase has a grain size of 1-50 nm.

The present invention provides a method for preparing the samarium-iron-based rare earth permanent magnet material containing the grain boundary phase described in the above technical solution, comprising:
providing raw materials of the alloy, melting and casting the raw materials to obtain a master alloy; and
subjecting the master alloy to rapid quenching and melt-spinning to obtain the samarium-iron-based rare earth permanent magnet material containing the grain boundary phase.

Preferably, the melting is conducted at a power of 14-19 kw.

Preferably, the casting is conducted at a power of 5-9 kw.

Preferably, the process of rapid quenching and melt-spinning is conducted by using a quartz tube with a diameter of 1-4 mm and a copper roller, wherein the distance from the nozzle of the quartz tube to the copper roller is 1-4 mm.

Preferably, the process of rapid quenching and melt-spinning is conducted at a melt temperature of 1000-1700° C. under a pressure difference between a gas storage tank and a furnace chamber of 0.02-0.06 MPa and a speed of rapid quenching of 5-50 m/s.

The present invention provides a magnetic device, comprising the samarium-iron-based rare earth permanent magnet material containing the grain boundary phase described in the above technical solution.

The present invention finds that both the composition of the alloy and the adjustment and control of the rapid quenching process will have a great impact on the grain size and microscopic appearance of the rapidly quenched strip sample. For example, the composition of the alloy, speed of the rapid quenching, pressure difference between gas tank and chamber, and temperature of the melting all have a huge impact on the uniformity and performance of samples. Therefore, the control of these parameters is the key to obtain a uniform nanocrystalline samarium-iron-based rare earth permanent magnet rapidly quenched strip containing a grain boundary phase, which is also a difficult problem to be solved by those skilled in the art. Further, the content of alloy component and the peed of the rapid quenching are the most important parameters in the rapid quenching process, which are the key to affecting the purity of the main phase and phase structure. According to the research of the present invention, it is found that when the chemical formula is SmₐFe_{b}Co_{c}Ti_{d}Mₑ, where 0.5≤a≤1.5, 7.5≤b≤9.0, 2.0≤c≤3.0, 0.5≤d≤1.5, 0.1≤e≤1.0, and M is the key additive element, and the rolling speed is controlled at 5-40 m/s, a stable samarium-iron-based rare earth permanent magnet rapidly quenched strip can be obtained.

### BRIEF DESCRIPTION OF DRAWINGS

FIG. 1 is the transmission electron microscope test diagram of the samarium-iron-based rare earth permanent magnet rapidly quenched strip prepared by Comparative example 1 of the present invention;

FIG. 2 is the element detection diagram of the samarium-iron-based rare earth permanent magnet rapidly quenched strip prepared by Comparative example 1 of the present invention;

FIG. 3 is the transmission electron microscope test diagram of the samarium-iron-based rare earth permanent magnet rapidly quenched strip containing a grain boundary phase prepared in Example 1 of the present invention;

FIG. 4 is the element detection diagram of the samarium-iron-based rare earth permanent magnet rapidly quenched strip containing a grain boundary phase prepared in Example 1 of the present invention;

FIG. 5 is the XRD diffraction pattern of the samarium-iron-based rare earth permanent magnet rapidly quenched strip prepared in Example 1 of the present invention.

### DETAILED DESCRIPTION

The present invention provides a samarium-iron-based rare earth permanent magnet material containing a grain boundary phase, having a chemical formula of:

SmₐFe_{b}Co_{c}Ti_{d}Mₑ formula I;
wherein, 0.5≤a≤1.5, 7.5≤b≤9.0, 2.0≤c≤3.0, 0.5≤d≤1.5, 0.1≤e≤2.0, and
M is selected from the group consisting of B, C, Al, Si and a combination thereof.

In the present invention, a is preferably 0.8-1.2, more preferably 1; b is preferably 8-8.5, more preferably 8.2-8.3; c is preferably 2.3-2.7, more preferably 2.5; d is preferably 0.8-1.2, more preferably 1%; e is preferably 0.5-1.5, more preferably 0.8-1.2, most preferably 1%.

In the present invention, the samarium-iron-based rare earth permanent magnet material containing the grain boundary phase preferably comprises:
a samarium-iron (cobalt)-based main phase, a grain boundary phase and an α-Fe phase.

In the present invention, preferably, there is mainly segregation distribution of non-magnetic elements in the grain boundary phase, and the grain boundary phase is uniformly wrapped on the surface of the samarium-iron-based main phase.

In the present invention, the samarium-iron-based main phase is in a volume content of preferably 70-99%, more preferably 75-95%, more preferably 80-90% %, most preferably 85% in the samarium-iron-based rare earth permanent magnet material containing the grain boundary phase; the grain boundary phase is in a volume content of preferably 1-30%, more preferably 5-25%, more preferably 10-20%, most preferably 15% in the samarium iron-based rare earth permanent magnet material containing a grain boundary phase; the α-Fe phase (soft magnetic phase) is in a volume content of preferably 1-20%, more preferably 5-15% %, more preferably 8-12%, most preferably 10% in the samarium iron-based rare earth permanent magnet material containing a grain boundary phase.

In the present invention, the samarium-iron-based main phase has a grain size of preferably 20-200 nm, more preferably 50-150 nm, more preferably 80-120 nm, most preferably 100 nm; the grain boundary phase has a grain size of preferably 2-100 nm, more preferably 10-80 nm, more preferably 20-60 nm, more preferably 30-50 nm, most preferably 40 nm.

The present invention provides a method for preparing the samarium-iron-based rare earth permanent magnet material containing the grain boundary phase described in the above technical solution, comprising:
providing raw materials of the alloy, melting and casting the raw materials to obtain a master alloy; and
subjecting the master alloy to rapid quenching and melt-spinning to obtain the samarium-iron-based rare earth permanent magnet material containing a grain boundary phase.

There is no special limitation to the alloy raw materials in the present invention, and the raw materials for preparing permanent magnetic materials well known to those skilled in the art are available. In the present invention, the raw materials that can provide Sm source, Fe source, Co source, Ti source and M source are available.

There is no special limitation to the method of providing raw materials of the alloy in the present invention, and the raw materials of the alloy can be provided according to the chemical formula I by a method well-known to those skilled in the art. In the process of providing raw materials, compensation for melting loss is preferably carried out, and the element having melting loss is Sm, i.e., the element Sm should be added in an additional amount of 1-30 wt %, more preferably 5-25%, more preferably 10-20%, most preferably 15%.

In the present invention, the melting is preferably carried out in a vacuum high-frequency induction furnace. The melting process is preferably carried out at a vacuum degree of (3-7)×10⁻² Pa, more preferably (4-6)×10⁻² Pa, most preferably 5×10⁻² Pa. In the melting process, gas washing is performed by using argon gas for preferably 2-4 times, more preferably 3 times. The melting is conducted at a power of preferably 14-19 kw, more preferably 15-18 kw, most preferably 16-17 kw. The casting is conducted at a power of preferably 5-9 kw, more preferably 6-8 kw, most preferably 7 kw. The melting is repeatedly melting the alloy for preferably 1-3 times, more preferably twice.

In the present invention, the method of melting and casting preferably comprises:
adding the provided alloy raw materials into a vacuum induction melting furnace, covering the furnace and vacuumizing to (3-7)×10⁻² Pa after the addition of the raw materials is completed, baking at a lower temperature to remove the water vapor and gas adsorbed on the surface of the raw materials, introducing high-purity argon gas after the vacuum is stabilized, gradually increasing the heating power, reducing the heating power after the raw materials are completely melted, keeping the temperature for 2 to 5 minutes, then casting the alloy liquid in a copper mold and cooling.

In the present invention, the lower temperature is preferably 1400-1800° C., more preferably 1500-1700° C., most preferably 1600° C. The vacuum degree after the vacuum is stabilized is preferably <2×10⁻² Pa. The pressure of introducing the argon gas is preferably 0.04-0.08 MPa, more preferably 0.05-0.07 MPa, most preferably 0.06 MPa. The purity of the argon gas is preferably 99.999%. The gradually increased power is within a range of preferably 12-18 kw, more preferably 13-17 kw, more preferably 14-16 kw, most preferably 15 kw. The reduced heating power is within a range of preferably 10-8 kw, more preferably 9 kw. The temperature is kept for preferably 3-4 minutes.

In the present invention, it is preferable to polish the surface impurities of the master alloy and crush the master alloy into small pieces before the rapid quenching and melt-spinning. The rapid quenching and melt-spinning is preferably carried out in a vacuum rapid quenching machine. The rare earth rapidly quenched thin strip containing the grain boundary phase is spun out of the vacuum rapid quenching machine.

In the present invention, in the process of rapid quenching and melt-spinning, the diameter of the quartz tube is preferably 1-4 mm, more preferably 2-3 mm. The distance from the nozzle of the quartz tube to the copper roller is preferably 1-4 mm, more preferably 2-3 mm. The melt temperature is preferably 1000-1700° C., more preferably 1100-1600° C., more preferably 1200-1500° C., most preferably 1300-1400° C. The melt temperature is preferably measured by using an infrared thermometer. The pressure difference between the gas tank and the furnace chamber is preferably 0.02-0.06 MPa, more preferably 0.03-0.05 MPa, most preferably 0.04 MPa. The speed of the rapid quenching is preferably 10-50 m/s, more preferably 20-40 m/s, most preferably 30 m/s.

The present invention provides a magnetic device, comprising: the samarium-iron-based rare earth permanent magnet material containing the grain boundary phase described in the above technical solution.

The rapidly quenched strip prepared by the present invention has low cost, and can be used to develop the magnetic devices in the fields of bonded magnetic powder and information communication. Compared with the prior art, it overcomes the problem of lack of grain boundary phase in samarium-iron-based rare earth permanent magnet materials and easiness of precipitating α-Fe, and provides new ideas for the subsequent development of new high-coercivity samarium-iron-based rare earth permanent magnets.

The microstructure of the samarium-iron-based rare earth permanent magnet material containing a grain boundary phase provided by the present invention not only comprises a samarium-iron-based main phase with permanent magnetic properties, but also comprises a grain boundary phase, which is not found in traditional samarium-iron-based rare earth permanent magnet materials. In the present invention, the samarium-iron-based main phase and the grain boundary phase are used to realize high magnetic performance, and complicated techniques are not required. Therefore, the present invention can be applied in low-cost rare earth permanent magnet materials.

### Example 1

Providing raw materials: Raw materials were weighed according to the molar ratio of each element in the stoichiometric formula Sm₁Fe_{8.8}Co_{2.2}Ti₁B_{0.25}.

Melting: The provided raw materials were added into a vacuum induction melting furnace. After the addition of the materials was completed, the furnace was covered and vacuumized to 5×10⁻² Pa. Then the raw materials were baked at a lower temperature to remove the water vapor and gas adsorbed on the surface of the raw materials. After the vacuum was stabilized (<2×10⁻² Pa), 0.06 MPa of high-purity argon gas (99.999%) was introduced. The heating power was gradually increased to 16.8 kw. After the raw materials were completely melted, the heating power was reduced to 8 kw, and the temperature was kept for 2-5 minutes. Then the steel liquid was casted in a copper mold and cooled to obtain a master alloy.

The surface impurities of the master alloy obtained above were polished. Then the master alloy was crushed and put into a quartz tube. The diameter of the quartz tube was 1 mm, and the distance from the nozzle of the quartz tube to the copper roller was 3 mm. The master alloy was melted in a vacuum high-frequency induction melting furnace. The melt temperature was measured to be 1600° C. by using an infrared thermometer. The pressure difference between the gas tank and the furnace chamber was 0.04 MPa. The melt master alloy was subjected to melt-spinning at a speed of rapid quenching of 25 m/s to obtain a uniform and stable rare earth permanent magnet rapidly quenched strip containing a grain boundary phase.

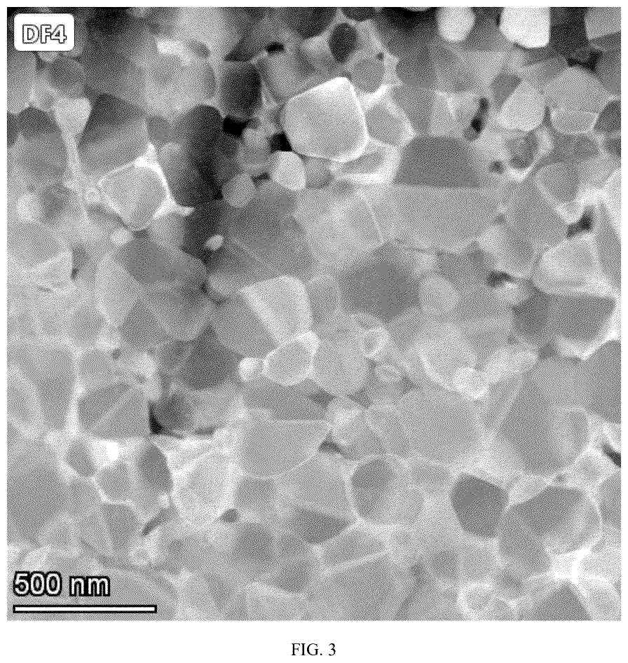

The transmission electron microscope photograph of the microstructure of the samarium-iron-based permanent magnet material containing the grain boundary phase prepared in Example 1 of the present invention is shown in FIG. 3. As it can be seen from FIG. 3, the microstructure of the samarium-iron-based permanent magnet material containing the grain boundary phase is mainly composed of a samarium-iron-based main phase and a grain boundary phase. The grain boundary phase is distributed along the grain boundary. The grain size of the main phase is 100-200 nm, and the grain size of the grain boundary phase is 3-30 nm.

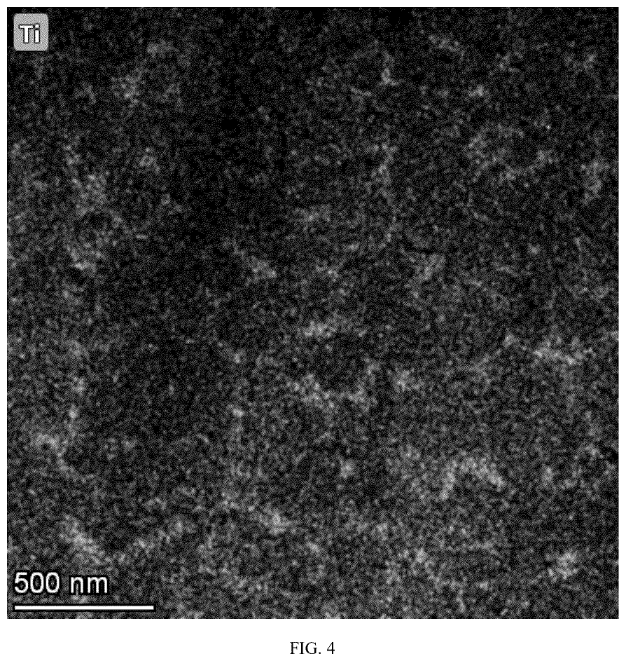

FIG. 4 shows the test results of the element distribution of the samarium-iron-based rare earth permanent magnet material containing the grain boundary phase prepared in Example 1. It can be seen that there is mainly segregation distribution of Ti element in the grain boundary phase.

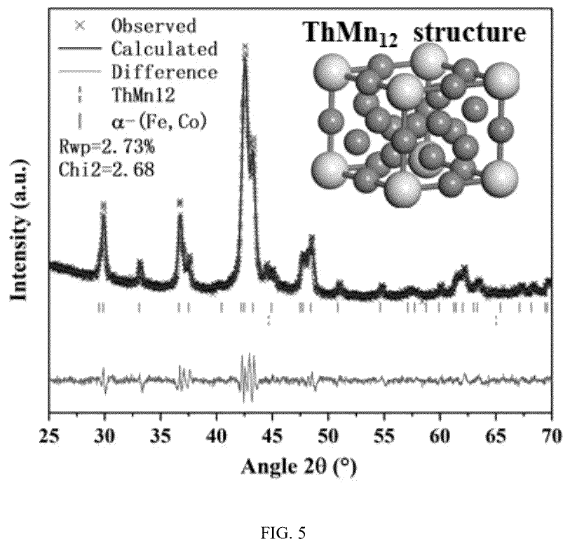

FIG. 5 is the XRD diffraction pattern of the samarium-iron-based rare earth permanent magnet rapidly quenched strip prepared in Example 1 of the present invention. It can be seen from FIG. 5 that the ratio of the main phase ThMn12 and the soft magnetic phase α-Fe is 97.58 wt. %: 2.42 wt. %.

### Example 2

A samarium-iron-based permanent magnet material containing a grain boundary phase was prepared according to the method of Example 1, except that the raw materials were weighed according to the molar ratio of each element in the stoichiometric formula Sm₁Fe_{8.8}Co_{2.2}Ti₁B_{0.5}.

### Example 3

A samarium-iron-based permanent magnet material containing a grain boundary phase was prepared according to the method of Example 1, except that the raw materials were weighed according to the molar ratio of each element in the stoichiometric formula Sm₁Fe_{8.8}Co_{2.2}Ti₁B₁.

### Example 4

A samarium-iron-based permanent magnet material containing a grain boundary phase was prepared according to the method of Example 1, except that the speed of the rapid quenching and melt-spinning was 40 m/s.

### Example 5

A samarium-iron-based permanent magnet material containing a grain boundary phase was prepared according to the method of Example 1, except that the raw materials are weighed according to the molar ratio of each element in the stoichiometric formula Sm₁Fe_{8.8}Co_{2.2}Ti₁B_{0.5}, and the speed of the rapid quenching and melt-spinning was 40 m/s.

### Example 6

A samarium-iron-based permanent magnet material containing a grain boundary phase was prepared according to the method of Example 1, except that the raw materials are weighed according to the molar ratio of each element in the stoichiometric formula Sm₁Fe_{8.8}Co_{2.2}Ti₁B_{0.75}, and the speed of the rapid quenching and melt-spinning was 40 m/s.

### Example 7

A samarium-iron-based permanent magnet material containing a grain boundary phase was prepared according to the method of Example 1, except that the raw materials are weighed according to the molar ratio of each element in the stoichiometric formula Sm₁Fe_{8.8}Co_{2.2}Ti₁B₁, and the speed of the rapid quenching and melt-spinning was 40 m/s.

### Comparative Example 1

Providing raw materials: Raw materials were weighed according to the molar ratio of each element in the stoichiometric formula Sm₁Fe_{8.8}Co_{2.2}Ti₁;

Melting: The provided raw materials were added into a vacuum induction melting furnace. After the addition of the materials was completed, the furnace was covered and vacuumized to 5×10⁻² Pa. Then the raw materials were baked at a lower temperature to remove the water vapor and gas adsorbed on the surface of the raw materials. After the vacuum was stabilized (<2×10⁻² Pa), 0.06 MPa of high-purity argon gas (99.999%) was introduced. The heating power was gradually increased to 15.7 kw. After the raw materials were completely melted, the heating power was reduced to 7.6 kw, and the temperature was kept for 2-5 minutes. Then the steel liquid was casted in a copper mold and cooled to obtain a master alloy.

The surface impurities of the master alloy obtained above were polished. Then the master alloy was crushed and put into a quartz tube. The diameter of the quartz tube was 1 mm, and the distance from the nozzle of the quartz tube to the copper roller was 3 mm. The master alloy was melted in a vacuum high-frequency induction melting furnace. The melt temperature was measured to be 1550° C. by using an infrared thermometer. The pressure difference between the gas tank and the furnace chamber was 0.04 MPa. The melt master alloy was subjected to melt-spinning at a speed of rapid quenching of 25 m/s to obtain a uniform and stable rare earth permanent magnet rapidly quenched strip containing a grain boundary phase.

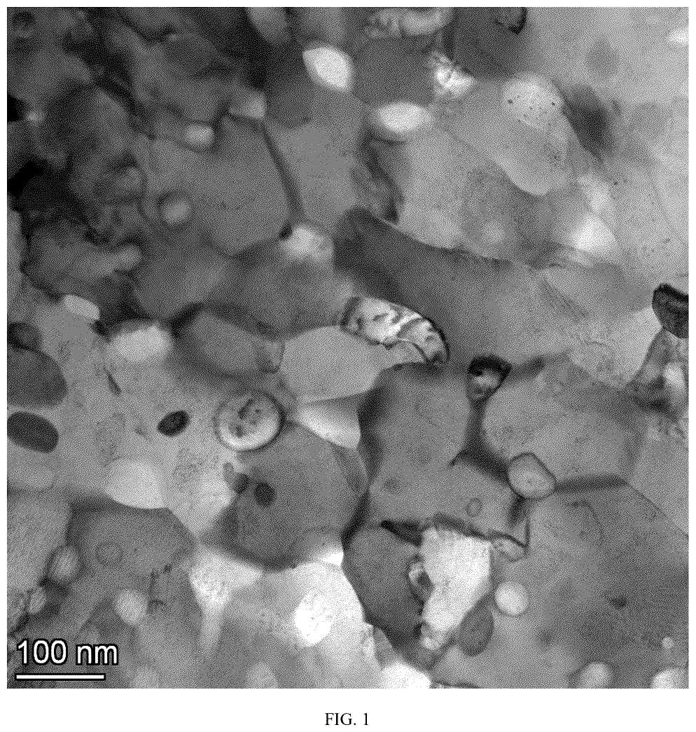

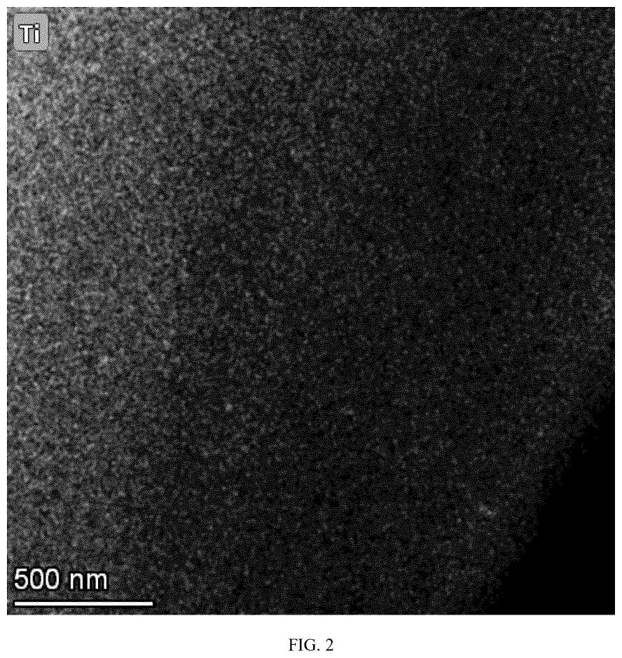

FIG. 1 is the transmission electron microscope test diagram of the samarium-iron-based rare earth permanent magnet rapidly quenched strip prepared by Comparative example 1 of the present invention; FIG. 2 is the element detection diagram of the samarium-iron-based rare earth permanent magnet rapidly quenched strip prepared by Comparative example 1 of the present invention. It can be seen from FIG. 1 and FIG. 2 that no grain boundary phase was observed in the alloy without addition of M element.

### Performance Test

The magnetic performance of the products prepared in the examples and comparative example of the present invention were tested by measuring hysteresis loops in an external magnetic field under vacuum conditions of a 9T magnetic field (instrument model: PPMS-EverCool).

The test results are as follows:

| | Saturation magnetization | Coercive |
|---|---|---|
| | intensity (emu/g) | force (Oe) |
| Comparative example 1 | 122.89 | 2493.84 |
| Example 1 | 125.64 | 5679.42 |
| Example 2 | 125.93 | 1154.33 |
| Example 3 | 123.81 | 1080.41 |
| Example 4 | 136.41 | 724.13 |
| Example 5 | 119.82 | 217.04 |
| Example 6 | 118.05 | 374.04 |
| Example 7 | 114.91 | 238.89 |

It can be seen that in Examples 1 to 7, by adding the key element M and by using the corresponding preparation process, a grain boundary phase uniformly wrapping the grains of the samarium-iron-based main phase was precipitated in the samarium-iron-based permanent magnet material. Compared with Comparative example 1, the coercive force of the rapidly quenched strip prepared in Example 1 was greatly increased.

The above are only preferred embodiments of the present invention. It should be noted that for those skilled in the art, without departing from the principle of the present invention, several improvements and modifications can also be made, and these improvements and modifications should also be considered as the protection scope of the present invention.

1. A samarium-iron-based rare earth permanent magnet material containing a grain boundary phase, having a chemical formula of:
SmₐFe_{b}Co_{c}Ti_{d}Mₑ formula I;
wherein, 0.5≤a≤1.5, 7.5≤b≤9.0, 2.0≤c≤3.0, 0.5≤d≤1.5, 0.1≤e≤2.0, and
M is selected from the group consisting of B, C, Al, Si and a combination thereof.

2. The samarium-iron-based rare earth permanent magnet material containing the grain boundary phase according to claim 1, comprising:
a Sm—Fe-based main phase, a grain boundary phase and an α-Fe phase;
wherein there is segregation distribution of non-magnetic elements in the grain boundary phase; and
the grain boundary phase is wrapped on the surface of the samarium-iron-based main phase.

3. The samarium-iron-based rare earth permanent magnet material containing the grain boundary phase according to claim 2, wherein the samarium-iron-based main phase is in a volume content of 70-99% in the samarium-iron-based rare earth permanent magnet material containing the grain boundary phase;
the grain boundary phase is in a volume content of 1-30% in the samarium-iron-based rare earth permanent magnet material containing the grain boundary phase;
the α-Fe phase is in a volume content of 1-20% in the samarium-iron-based rare earth permanent magnet material containing the grain boundary phase.

4. The samarium-iron-based rare earth permanent magnet material containing the grain boundary phase according to claim 2, wherein, the samarium-iron-based main phase has a grain size of 20-500 nm; and
the grain boundary phase has a grain size of 1-50 nm.

5. A method for preparing the samarium-iron-based rare earth permanent magnet material containing the grain boundary phase according to claim 1, comprising:
providing raw materials of the alloy, melting and casting the raw materials to obtain a master alloy; and
subjecting the master alloy to rapid quenching and melt-spinning to obtain the samarium-iron-based rare earth permanent magnet material containing the grain boundary phase.

6. The method according to claim 5, wherein the melting is conducted at a power of 14-19 kw.

7. The method according to claim 5, wherein the casting is conducted at a power of 5-9 kw.

8. The method according to claim 5, wherein the process of rapid quenching and melt-spinning is conducted by using a quartz tube with a diameter of 1-4 mm and a copper roller, wherein the distance from the nozzle of the quartz tube to the copper roller is 1-4 mm.

9. The method according to claim 5, wherein the process of rapid quenching and melt-spinning is conducted at a melt temperature of 1000-1700° C. under a pressure difference between a gas storage tank and a furnace chamber of 0.02-0.06 MPa and a speed of rapid quenching of 5-50 m/s.

10. A magnetic device, comprising the samarium-iron-based rare earth permanent magnet material containing the grain boundary phase according to claim 1.
